(19) United States
(12) Patent Application Publication
(10) Pub. No.: US 2003/0077404 A1
(43) Pub. Date: Apr. 24, 2003

(54) Hangerless magnetic paint conveyor system

(75) Inventor: Donald L. Hartley, Colwich, KS (US)

Correspondence Address: LEYDIG, VOIT & MAYER, LTD., (SEATTLE OFFICE), TWO PRUDENTIAL PLAZA, SUITE 4900, CHICAGO, IL, 60601-6780, US

(73) Assignee: The Coleman Company, Inc.

(21) Appl. No.: 10/044,566

(22) Filed: Oct. 19, 2001

(51) Int. Cl. B05D 1/12; B05D 5/12

(52) U.S. Cl. 427/598; 118/324; 118/326; 427/180

(57) ABSTRACT

A magnetic paint conveyor system having a conveyor for conveying ferromagnetic items into and through a powder-coating paint booth. A permanent magnet is mounted on one side of a magnetically-conductive conveyor belt for the conveyor. As the magnetically-conductive conveyor belt slides over the permanent magnet, magnetic attractive forces are transferred through the belt. The ferromagnetic items are magnetically connected to the magnetically-conductive conveyor belt over the length of the permanent magnet. A feed conveyor may be provided for supplying ferromagnetic items to the magnetized portion of the magnetically-conductive conveyor belt. The ferromagnetic items fall off the magnetically-conductive conveyor belt onto an exit conveyor when they extend just beyond the end of the permanent magnet. The exit conveyor may lead to, for example, a curing oven. A belt cleaner is provided to clean powder paint particles off the belt for reuse.

### FIELD OF THE INVENTION

The present invention relates to conveyor systems, and more particularly to paint conveyor systems.

### BACKGROUND OF THE INVENTION

Powder coating is an advanced, yet simple, way of spray painting very fine, dry, plastic powder paint particles onto a metal surface, as in the production of machinery parts or window frames. As the powder paint particles gently leaves the front of a spray gun, they are charged with static electricity, which causes the powder paint particles to attract to the part being coated. The powder paint particles are charged by either adding or removing electrons from the particles. When negatively charged, the powder paint particles have an excessive amount of electrons, and the powder paint particles are attracted to an object that has fewer electrons. If positively charged, the powder paint particles have fewer electrons and are attracted to an object where they can find electrons to replace the missing electrons. A ground is one source for discarding or obtaining electrons, and therefore the powder paint particles will often cling to a grounded part.

A part that has been powder coated and not yet cured will have the powder paint particles cling to its surface for a long period of time, even as long as a few weeks. However, typically, shortly after being powder coated, a part is placed in an oven. While in the oven, the powder paint melts and flows into a beautiful and durable finish. This process is called “curing” of the powder paint particles.

Powder coating has many advantages. Primers are not necessary, and there are no runs or drips such as there are with wet paint. Powder coating is extremely friendly to the environment because the overspray often circulates within a paint booth and is recycled back to the spray gun. In addition, because the powder paint particles do not use solvents as a carrier, there is none of the associated air pollution.

Often, to powder coat multiple parts, the parts are drawn through a paint booth on a conveying system. The powder paint particles are applied to the parts as they are conveyed through the paint booth, and the parts are then typically conveyed through an oven for a curing cycle. This process allows a continuous stream of parts to be painted and cured with minimal operator contact with the parts.

Although contemporary powder-coating paint conveyors work well for their intended purpose, there are problems with their associated use and maintenance. The parts that are being painted are typically attached to the conveyor by hangers or hooks. Attachment of parts to these hangers or hooks, and maintenance of these hangers or hooks, may be expensive. For example, one type of hanger includes a magnet attached to an end of a long, steel rod. The rod is attached to a conveyor, and the rod is grounded in some fashion so that an item attached to the hanger may properly attract the electrostatically-charged powder paint particles. Attachment of a part to such a hanger may be difficult, requiring manual labor, or complex, expensive machinery. In addition, because the rods and the magnets are grounded, the powder paint material often clings to these items, and cleaning of the rods and the magnets is required to prevent later sparking or arcing. In addition, in some applications, the magnetic hangers are used to hold the parts during curing. In such applications, the powder paint material on the hangers also cures, and must be regularly removed so that the magnet does not lose its attraction, and to avoid sparking or arcing. Using hooks to hang parts on the paint conveyors has similar problems.

### SUMMARY OF THE INVENTION

The present invention is directed to a magnetic conveyor for conveying ferromagnetic items into and through a powder-coating paint booth. Instead of using conventional hooks or hangers on an overhead conveyor, the present invention includes a permanent magnet mounted on one side of a continuous, magnetically-conductive conveyor belt. As the magnetically-conductive conveyor belt slides over the permanent magnet, magnetic attractive forces are transferred through the magnetically-conductive conveyor belt. In this manner, ferromagnetic items may be magnetically connected to the magnetically-conductive conveyor belt over the length of the permanent magnet.

The permanent magnet extends through a paint booth. A front end of the permanent magnet extends outside the paint booth, so that ferromagnetic items may be attached to the magnetically-conductive conveyor belt before they enter the paint booth. In accordance with one aspect of the present invention, a feed conveyor may be provided for supplying ferromagnetic items to the magnetized portion of the magnetically-conductive conveyor belt that extends outside the inlet of the paint booth. The feed conveyor advances the ferromagnetic items to just under the magnetically-conductive conveyor belt, where they are gently lifted by the magnetic attractive forces in the belt. The transition is made more smooth by the feed conveyor advancing the ferromagnetic items in the direction of the movement of the magnetically-conductive conveyor belt, and at a similar speed to the speed at which the conveyor belt is traveling.

The ferromagnetic items attached to the magnetically-conductive conveyor belt then advance into the paint booth, where they are powder-coated or otherwise painted. For powder-coating, the magnetically-conductive conveyor belt is grounded, and that ground is transferred to the ferromagnetic items. In this manner, the electrostatically-charged powder paint particles may adhere to the ferromagnetic items while the items are in the paint booth.

The end of the permanent magnet extends outside the paint booth. The ferromagnetic items fall off the magnetically-conductive conveyor belt when they extend just beyond the end of the permanent magnet. The magnetic attractive forces in the magnetically-conductive conveyor belt decrease gradually from the end of the permanent magnet. Thus, the ferromagnetic items are gently dropped from the magnetically-conductive conveyor belt. These items may fall onto an exit conveyor, which may lead to, for example, a curing oven. To aid in a gentle fall, in accordance with one aspect of the present invention, the exit conveyor travels in a direction that is the same as the movement of the magnetically-conductive conveyor belt, and at about the same speed. This configuration does not result in a drastic change of direction for the ferromagnetic items, thus providing a smooth transition for the exiting powder-coated parts.

Some of the powder paint particles may cling to the magnetically-conductive conveyor belt as it rotates through the paint booth. To aid in their removal, a belt cleaner, such as one or more brushes or other suitable devices, may be provided for removing powder coating or other paint particles from the magnetically-conductive conveyor belt. In this manner, the environment for the magnetic conveyor may be protected, and powder particles may be reused. This feature alleviates most of the need for cleaning of the magnetically-conductive conveyor belt, greatly decreasing maintenance of the magnetic conveyor painting system.

The belt cleaner may direct the powder particles into chute, which may dump, for example, into a hopper for the powder spray gun or guns. Alternatively, the chute may lead directly into a catch basin, wherein the powder particles in the catch basin may later be emptied into the hopper. However, if the chute leads directly into the hopper, less maintenance is required.

The magnetic conveyor painting system of the present invention greatly reduces maintenance required in an electromagnetic painting environment. Ferromagnetic items may automatically be fed onto the magnetically-conductive conveyor belt by a relatively inexpensive feed conveyor. No complex or expensive machinery is required to attach the ferromagnetic items. Because hooks or hangers are not required for the connection, the associated time spent cleaning the hooks or hangers is eliminated.

The belt cleaner removes most powder paint particles from the magnetically-conductive conveyor belt, thus providing a virtually maintenance free belt. Also, because the powder particles may be captured and reused, the belt cleaner also reduces waste in the painting process.

The exit conveyor provides a smooth transition into a curing oven, assuring that the powdered coating on the ferromagnetic items is not damaged. This structure also does not require that the mechanism that holds the ferromagnetic items during powder coating holds the items during curing, avoiding further cleaning.

Other advantages will become apparent from the following detailed description when taken in conjunction with the drawings, in which:

### BRIEF DESCRIPTION OF THE DRAWINGS

FIG. 1 is a perspective view of a hangerless magnetic paint conveyor system incorporating the present invention;

FIG. 2 is a cutaway perspective view of a portion of the hangerless magnetic paint conveyor system of FIG. 1, showing the platform removed from a base for the body weigh powder paint system;

FIG. 3 is section view of a portion of a magnetically-conductive conveyor belt and surrounding structure for use in the hangerless magnetic paint conveyor system of FIG. 1;

FIG. 4 is a diagrammatic view of an inlet portion of the magnetic paint conveyor system of FIG. 1; and

FIG. 5 is a diagrammatic view of an outlet portion of the magnetic paint conveyor system of FIG. 1;.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details. Furthermore, well-known features may be omitted or simplified in order not to obscure the present invention. In addition, to the extent that orientations of the invention are described, such as “top,” “bottom,” “front,” “bottom,” and the like, the orientations are to aid the reader in understanding the invention, and are not meant to be limiting.

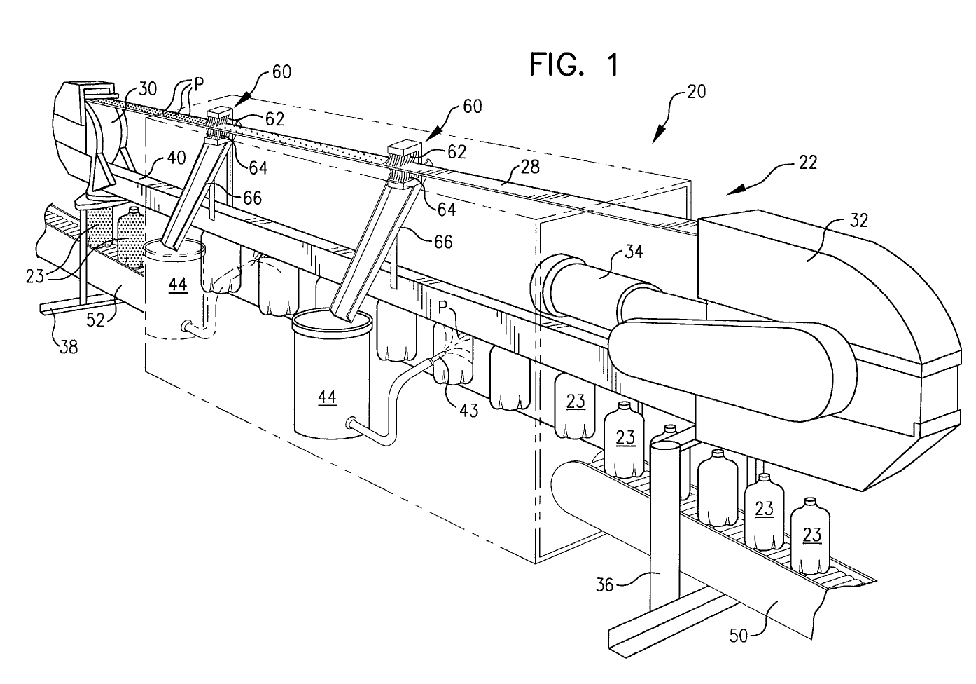

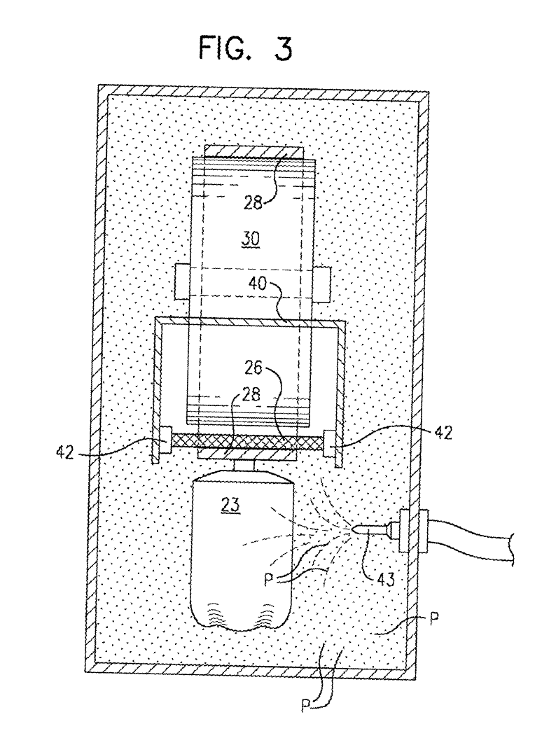

Referring to FIG. 1 of the drawings, there is shown a hangerless magnetic paint conveyor system designated generally by reference numeral 20. Generally described, the magnetic paint conveyor system 20 includes a conveyor 22 for conveying ferromagnetic items 23 into and through a powder-coating paint booth 24. In accordance with the present invention, a permanent magnet 26 (FIG. 3) is mounted on one side of a continuous, magnetically-conductive conveyor belt 28 for the conveyor 22. As the magnetically-conductive conveyor belt 28 slides over the permanent magnet 26, magnetic attractive forces are transferred through the magnetically-conductive conveyor belt. In this manner, the ferromagnetic items 23 may be magnetically connected to the magnetically-conductive conveyor belt 28 over the length of the permanent magnet 26.

The conveyor 22 includes a pair of wheels 30 (only one of which is shown in FIG. 1, but the other of which is mounted in a housing 32). The continuous, magnetically-conductive conveyor belt 28 extends around the wheels 30. A motor 34 (only the housing for the motor is shown, but the structure and operation of the motor is known in the art) drives one of the wheels 30 in a conventional manner, such as by a belt connection or other suitable drive. The other wheel 30 is passive, and is turned by the rotation of the driven wheel and the connection of the two wheels to the continuous, magnetically-conductive conveyor belt 28. Rotation of the wheels 30 causes successive portions of the length of the magnetically-conductive belt to travel along a circular path, i.e., around the wheels.

The conveyor 22 is preferably arranged and configured so that the continuous, magnetically-conductive conveyor belt 28 is electrically grounded. For example, frames 36, 38 for the wheels 30 may be electrically conductive (e.g., steel), and may be connected to a suitable ground, and the wheels may be steel, so that they are grounded through the frames. Similarly, the continuous, magnetically-conductive conveyor belt 28 may be steel or another suitable electrically conductive material, so that the belt is grounded through the wheels 30.

The mounting of the permanent magnet 26 relative to the continuous, magnetically-conductive conveyor belt 28 is shown in FIG. 3. A housing 40 extends around the top and sides of the continuous, magnetically-conductive conveyor belt 28, and the permanent magnet 26 is mounted in the housing so that it extends parallel and just above the continuous, magnetically-conductive conveyor belt. The housing 40 may be, for example, a U-shaped bracket with its open end facing downward, and its sides extending down to the sides of the continuous, magnetically-conductive conveyor belt 28. The top of the housing 40 in such an embodiment extends over the continuous, magnetically-conductive conveyor belt 28. The continuous, magnetically-conductive conveyor belt 28 is pulled taut against the permanent magnet 26 by the wheels 30, and magnetic attraction of the permanent magnet holds the continuous, magnetically-conductive conveyor belt against its surface.

The continuous, magnetically-conductive conveyor belt 28 and the housing 40 extend through the paint booth 24. The housing 40 is insulated, for example by an epoxy paint. The insulation prevents powdered paint particles in the paint booth 24 from being attracted to the housing 40.

The permanent magnet 26 may be, for example, a 1 and 29/32 inch thick permanent magnet, having pull weights of 6.75 pounds with a ⅙ inch air gap, 5.75 pounds with a ⅛ air gap, and 4.25 pounds with a ¼ inch air gap. The size and strength of the permanent magnet 26 may be altered as necessary for a particular painting application, as further described below. The permanent magnet 26 is suitably attached to the housing 40, for example by insulated mounts 42. In accordance with one aspect of the present invention, the permanent magnet 26 is of sufficient length that it extends out of both ends of the paint booth 24. As one example, the permanent magnet 26 is fourteen (14) feet in length, and the paint booth 24 is seven (7) feet long. The top, return portion of the continuous, magnetically-conductive conveyor belt 28 is exposed, and extends through a top portion of the paint booth 24.

The paint booth 24 may be, for example, a conventional powder-coating paint booth, designed to apply powder paint particles P (FIG. 3) to a part (e.g., the ferromagnetic items 23), and to recapture paint particles P that are not applied to the part. In the embodiment shown, the paint booth 24 is open at inlet and outlet ends, and closed along its length. However, any structure, including an open one, may be used, as long as the paint booth is designed for applying paint to the ferromagnetic items. The powder paint booth includes one or more spray guns 43 (only one is shown in the drawings, but more may be used) that are designed to spray the paint particles P, and that electrostatically charge the particles P as they are sprayed, in a manner known in the art. A person of skill in the art of powder painting may supply an appropriate number of spray guns, and arrange the guns appropriately, so that parts that are powder coated by the magnetic paint conveyor system 20 may have the proper application of powder paint particles P.

The spray guns 43 include hoppers 44 for supplying the powder paint particles P. As is known in the art, the powder paint booth 24 may be configured, and the air flow may be arranged within the paint booth, so that powder paint particles P that are not attracted to and attached on a part are recaptured and redirected back into the hoppers 44. To this end, appropriate vents or vacuum may be used to direct the unused powder paint particles P into the hoppers 44. The arrangement of the paint booth 24 and air flow within the paint booth may also be configured to minimize powder paint particles P from escaping out of the open ends of the powder paint booth 24.

An inlet conveyor 50 is provided at the inlet end of the paint booth 24. The inlet conveyor 50 is preferably configured and arranged so that it feeds the ferromagnetic items 23 to just under a portion of the continuous, magnetically-conductive conveyor belt 28 that is in contact with the permanent magnet 26. The function and operation of the inlet conveyor 50 is described below.

An exit conveyor 52 is located at the outlet end of the paint booth 24, under the continuous, magnetically-conductive conveyor belt 28. As further described below, the exit conveyor 52 is arranged so that it may catch and convey the ferromagnetic items 23 after they are released from the end of the permanent magnet 26.

In operation, the ferromagnetic items 23 are placed on the inlet conveyor 50 and are fed into the magnetic paint conveyor system 20. “Ferromagnetic item,” as used herein, is meant a part that is magnetically attractive, in that at least a portion of the part includes a material that attaches to a magnetically-charged member.

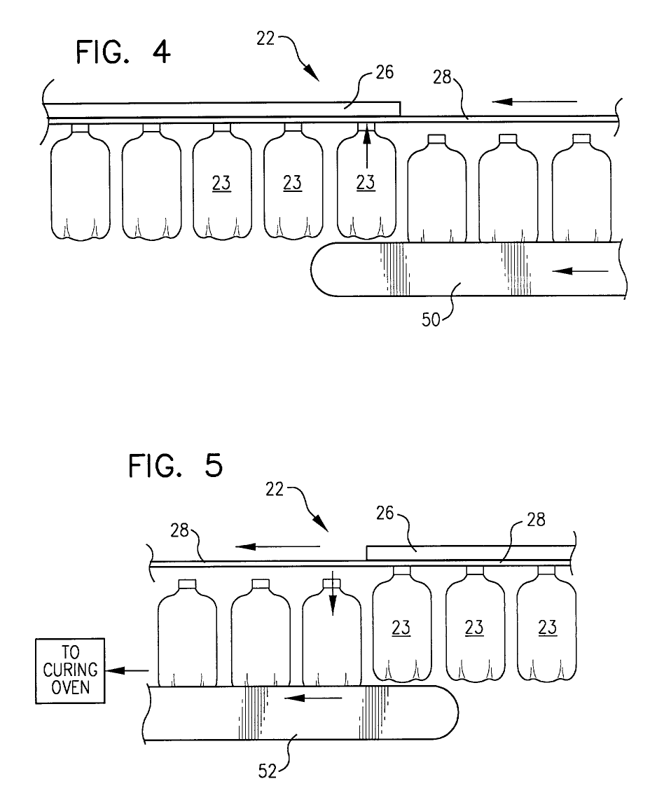

The permanent magnet 26 magnetically charges the portion of the continuous, magnetically-conductive conveyor belt 28 in contact with the permanent magnet 26. Although the described embodiment utilizes a permanent magnet, any mechanism may be used to magnetically charge a portion of the continuous, magnetically-conductive conveyor belt 28, including, but not limited to, an electromagnet. Thus, as used herein, a “magnet” is meant broadly to mean such a mechanism, and where “permanent magnet” is used, such a mechanism may be used as a substitute. As can be seen in FIG. 4, as the ferromagnetic items 23 approach the magnetically-charged inlet portion of the continuous, magnetically-conductive conveyor belt 28, the ferromagnetic items are lifted by magnetic attraction into contact with the continuous, magnetically-conductive conveyor belt. The magnetic charge is sufficient to hold the ferromagnetic items 23 against the continuous, magnetically-conductive conveyor belt 28 along the portion of the belt that is in contact with the permanent magnet 26. To this end, the permanent magnet 26 is of sufficient strength and size, and the continuous, magnetically-conductive conveyor belt 28 is sufficiently magnetically-conductive that the belt has a magnetic force that is sufficient to firmly hold the ferromagnetic items 23 against the belt.

Although the continuous, magnetically-conductive conveyor belt 28 is shown as having a constant cross-section, it may have protrusions or other formations onto which the ferromagnetic items 23 attach. In addition, the continuous, magnetically-conductive conveyor belt 28 may not be magnetically conductive along its length or across a width of the belt, so that only varied portions of the continuous, magnetically-conductive conveyor belt 28 attract the ferromagnetic items 23.

In the embodiment shown, the ferromagnetic items 23 are propane cylinders that weigh 1 pound, the permanent magnet is sized as described above, and the continuous, magnetically-conductive conveyor belt 28 is a steel band having a thickness of 0.018 inches. For this application, the permanent magnet 26 and the continuous, magnetically-conductive conveyor belt 28 are sufficiently sized to hold the propane cylinders at a top end firmly against the belt. The permanent magnet 26 and the continuous, magnetically-conductive conveyor belt 28 may be sized and/or shaped differently for other ferromagnetic items 23.

As can be seen in FIG. 4, the ferromagnetic items 23 approach the magnetically-charged portion of the continuous, magnetically-conductive conveyor belt 28, and are lifted by the magnetic forces from the inlet conveyor 50. Preferably, the ferromagnetic items 23 approach the continuous, magnetically-conductive conveyor belt 28 in a direction of travel of the continuous, magnetically-conductive conveyor belt, so that they may remain properly centered on the belt when attached (i.e., they are not apt to slide sideways). In addition, the speed of the input conveyor 50 is not substantially different from, or substantially the same as, the speed of the continuous, magnetically-conductive conveyor belt 28, so that the entry of the ferromagnetic items 23 is made more stable. As used herein, when referencing the speeds of the conveyors, “substantially the same” means a speed that is sufficient to provide momentum for the ferromagnetic items 23 so that the items are not yanked from the conveyor in an unstable manner.

The ferromagnetic items 23, having been attached to the continuous, magnetically-conductive conveyor belt 28, travel into the paint booth 24, where the ferromagnetic items 23 have powdered paint material sprayed thereon by the spray guns 43 (e.g., FIG. 3). The ferromagnetic items 23 are grounded by the continuous, magnetically-conductive conveyor belt 28, and thus attract the electrostatically-charged powder paint particles P. During the application of the powder paint particles P, the ferromagnetic items 23 continue to travel through the paint booth 24.

After exiting the paint booth 24, the ferromagnetic items 23 reach the end of the permanent magnet 26, where the magnetic attraction of the continuous, magnetically-conductive conveyor belt 28 ends. The ferromagnetic items 23 then are released of their magnetic hold, and drop off the continuous, magnetically-conductive conveyor belt 28 onto the exit conveyor 52 (FIG. 5). As with the inlet conveyor 50, the exit conveyor 52 preferably travels at substantially the same speed and direction as the continuous, magnetically-conductive conveyor belt 28, permitting a stable, smooth transition between the continuous, magnetically-conductive conveyor belt and the exit conveyor. The exit conveyor may then lead the ferromagnetic items 23 into an oven for curing of the powder paint particles P.

The magnetic conveyor painting system 20 of the present invention greatly reduces maintenance required in an electromagnetic painting environment. Ferromagnetic items 23 may automatically be fed onto the continuous, magnetically-conductive conveyor belt 28 by a the relatively inexpensive input conveyor 50. No complex or expensive machinery is required to attach the ferromagnetic items, but instead, the magnetic attraction in the continuous, magnetically-conductive conveyor belt 28 lifts the items into contact with the belt. Because hooks or hangers are not required for the connection, the associated time spent cleaning the hooks is eliminated. The exit conveyor 52 provides a smooth transition into a curing oven, assuring that the powdered coating on the ferromagnetic items 23 is not damaged. This structure also does not require that the mechanism that holds the ferromagnetic items during powder coating holds the items during curing, avoiding further cleaning.

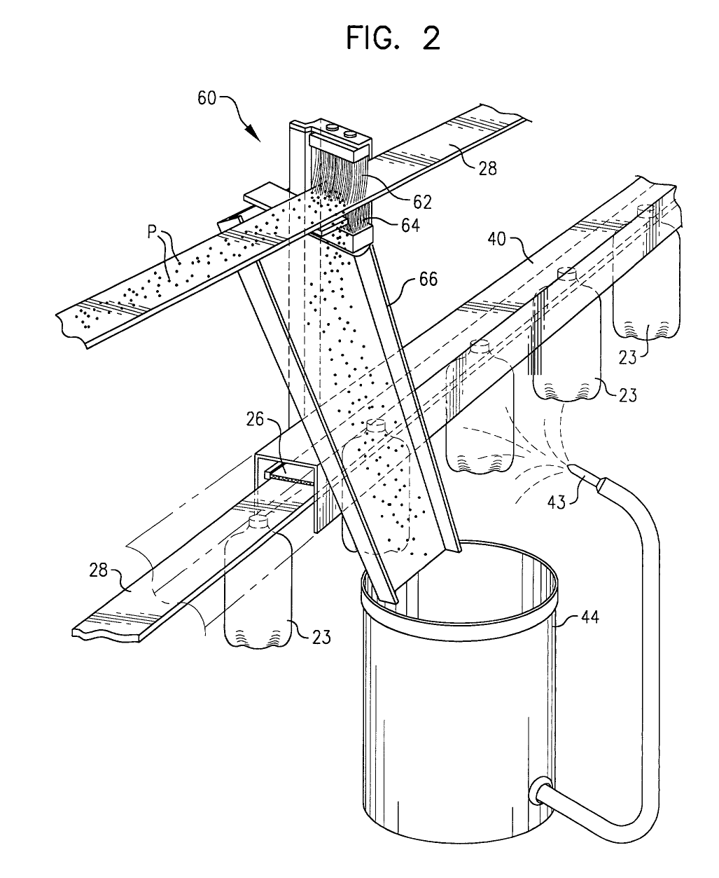

Because the continuous, magnetically-conductive conveyor belt 28 is grounded, some of the electrostatically-charged powder paint particles P may cling to the belt as it rotates through the paint booth 24. To remove these powder paint particles P, and to recover the powder paint particles P for further use, the present invention provides belt cleaners 60, best shown in FIG. 2. Each belt cleaner 60 includes a pair of brushes 62, 64 mounted on the return portion of the conveyor that is inside the paint booth 24. One brush 62 is mounted above the continuous, magnetically-conductive conveyor belt 28, and the other brush 64 is mounted below the belt. The brushes 62, 64 swipe the powder paint particles P from the continuous, magnetically-conductive conveyor belt 28, and direct them into a chute 66. The chute 66 dumps the powder particles P into a hopper 44 for one of the spray guns, where the particles P may be reused.

Although two brushes 62, 64 are shown for the belt cleaners, other structures may be used for swiping the powder paint particles P from the continuous, magnetically-conductive conveyor belt 28, including, but not limited to, vacuum, cloths, sweepers, and the like. However, the brushes 62, 64 shown are an inexpensive mechanism for removing the powder paint particles, and can be easily replaced when worn. In addition, although the disclosed belt cleaners 60 utilize chutes 66, other mechanisms may used to direct the powder paint particles into the hoppers, including, but not limited to, hoses, gravity, or air flow devices. The powder paint particles P may also be directed into an intermediate vessel, such as a container, and then dumped into the hopper 44. However, by directing the powder paint particles directly into the hoppers 44, maintenance is minimized.

By using two belt cleaners 60, the effectiveness of cleaning of the belt is increased. However, if desired, only one or more than two belt cleaners 60 may be used for an application.

The self-cleaning feature provided by the belt cleaners 60 eliminates most other cleaning of the magnetically-conductive conveyor belt 28, thus providing a virtually maintenance free belt. Also, because the powder paint particles P may be captured and reused, this feature also reduces waste in the painting process.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

What is claimed is:

1. A paint system, comprising:
a magnetically-conductive belt mounted so that successive portions of the length of the magnetically-conductive belt travel along a path;
a magnet mounted along a portion of the path, the magnet having sufficient magnetic strength and the magnetically-conductive belt being sufficiently magnetically-conductive such that, a part of the magnetically-conductive belt in the portion has a magnetic force from the magnet, the magnetic force being sufficient to hold ferromagnetic items against the belt as the magnetically-conductive belt travels along the portion of the path; and
a paint booth mounted along the portion and configured to apply paint particles to ferromagnetic items that are held by the magnetically-conductive belt as the magnetically-conductive belt travels along the portion of the path.

2. The paint system of claim 1, wherein the paint booth comprises at least one powder paint spray gun.

3. The paint system of claim 1, wherein the magnetically-conductive belt is electrically ground, and wherein ferromagnetic items held by the magnetic force are electrically ground through the magnetically-conductive belt.

4. The paint system of claim 1, wherein the magnet is a permanent magnet.

5. The paint system of claim 1, wherein a portion of the magnet extends partly out of an inlet of the paint booth.

6. The paint system of claim 5, further comprising an input conveyor for conveying ferromagnetic items to the first portion.

7. The paint system of claim 6, wherein the input conveyor extends under the magnetically-conductive belt.

8. The paint system of claim 7, wherein the input conveyor is spaced from the magnetically-conductive belt a sufficient amount that ferromagnetic items are lifted from the input conveyor by the magnetic force.

9. The paint system of claim 7, wherein a release end of the input conveyor extends substantially parallel to the magnetically-conductive belt.

10. The paint system of claim 9, wherein the input conveyor conveys at a speed that is substantially equal to a speed of the magnetically-conductive belt.

11. The paint system of claim 1, wherein a portion of the magnet extends partly out of an outlet of the paint booth.

12. The paint system of claim 11, further comprising an exit conveyor for conveying ferromagnetic items from the second portion.

13. The paint system of claim 12, wherein the exit conveyor extends under the magnetically-conductive belt.

14. The paint system of claim 13, wherein the exit conveyor is spaced from the magnetically-conductive belt a sufficient amount that, when ferromagnetic items are conveyed by the magnetically-conductive belt beyond the magnet, they are dropped onto the exit conveyor.

15. The paint system of claim 14, wherein an input end of the exit conveyor extends substantially parallel to the magnetically-conductive belt.

16. The paint system of claim 15, wherein the exit conveyor conveys at a speed that is substantially equal to the speed of the magnetically-conductive belt.

17. The paint system of claim 1, wherein the magnetically-conductive belt comprises a continuous belt.

18. The paint system of claim 1, further comprising a belt cleaner for removing paint particles from a portion of the magnetically-conductive belt after the portion of the magnetically-conductive belt travels through the paint booth.

19. The paint system of claim 18, wherein the belt cleaner comprises a first brush mounted over and in contact with the magnetically-conductive belt, and a second brush mounted under and in contact with the magnetically-conductive belt.

20. The paint system of claim 18, wherein the belt cleaner routes paint particles removed from the magnetically-conductive belt to the paint booth for reuse.

21. A paint system, comprising:
a grounded, continuous, magnetically-conductive belt mounted so that successive portions of the length of the magnetically-conductive belt travel along a path;
a magnet mounted along a portion of the path, the magnet having sufficient magnetic strength and the magnetically-conductive belt being sufficiently magnetically-conductive such that, a part of the magnetically-conductive belt in the portion has a magnetic force from the magnet, the magnetic force being sufficient to hold ferromagnetic items against the magnetically-conductive belt as the magnetically-conductive belt travels along the portion of the path, and wherein ferromagnetic items held against the magnetically-conductive belt are grounded through the magnetically-conductive belt; and
a powder paint booth mounted along the portion and configured to apply powder paint ferromagnetic items that are grounded by and held by the magnetically-conductive belt as the magnetically-conductive belt travels along the portion of the path.

22. The paint system of claim 21, further comprising a belt cleaner for removing paint particles from a portion of the magnetically-conductive belt after the portion of the magnetically-conductive belt travels through the paint booth.

23. The paint system of claim 22, wherein the belt cleaner comprises a first brush mounted over and in contact with the magnetically-conductive belt, and a second brush mounted under and in contact with the magnetically-conductive belt.

24. The paint system of claim 22, wherein the belt cleaner routes paint particles removed from the magnetically-conductive belt to the paint booth for reuse.

25. The paint system of claim 24, wherein the belt cleaner comprises a chute for routing the paint particles.

26. The paint system of claim 22, wherein belt cleaner is located inside the paint booth.

27. The paint system of claim 26, wherein the paint booth comprises a spray gun with a hopper, and wherein the belt cleaner routes paint particles removed from the magnetically-conductive belt to the hopper for reuse.

28. The paint system of claim 27, wherein the belt cleaner comprises a chute for routing the paint particles.

29. A method of painting, comprising:
grounding a magnetically-conductive belt;
sliding the magnetically-conductive belt along a magnet so that the magnetically-conductive belt has a magnetic force;
attaching a ferromagnetic item to the magnetically-conductive belt using the magnetic force so that the ferromagnetic item slides along the magnet with the magnetically-conductive belt; and
applying powder paint particles to the ferromagnetic item while it is attached to the magnetically-conductive belt.

30. The method of claim 29, further comprising supplying the ferromagnetic items to the magnetically-conductive belt via an input conveyor.

31. The method of claim 30, further comprising lifting the items from the input conveyor using the magnetic force.

32. The method of claim 29, further comprising causing the ferromagnetic item to slide with the magnetically-conductive belt along the magnet and beyond the magnet, where the magnetic force is not present so that the ferromagnetic item is released from the magnetically-conductive belt.

33. The method of claim 32, further comprising releasing the ferromagnetic item onto an exit conveyor.

34. The method of claim 29, further comprising automatically cleaning powder paint particles from the magnetically-conductive belt as it slides relative to the magnet so as to collect removed paint particles.

35. The method of claim 34, further comprising routing the removed paint particles so that they may be applied to another ferromagnetic item.
